(19) United States
(12) Patent Application Publication
(10) Pub. No.: US 2024/0386438 A1
(43) Pub. Date: Nov. 21, 2024

(54) REGULATION CONTROL SYSTEM

(71) Applicant: Capital One Services, LLC, McLean, VA (US)

(72) Inventors: Balinda CHU, Midlothian, VA (US); Anne HAINES, Mechanicsville, VA (US); Christiana WICKERSHAM, North Chesterfield, VA (US); Lori Ann SASLAW, Powhatan, VA (US)

(73) Assignee: Capital One Services, LLC, McLean, VA (US)

(21) Appl. No.: 18/199,547

(22) Filed: May 19, 2023

(51) Int. Cl. G06Q 30/018

(52) U.S. Cl. CPC G06Q 30/018

(57) ABSTRACT

Disclosed herein are system, method, and computer program product embodiments for a regulation control system. An embodiment operates by identifying a new regulation that is applicable to an organization, and generating an alert. A decision confirming that the new regulation is applicable to a function of the organization is received, and the new regulation is assigned to a first person responsible for generating a control. A status update from the first person is received. A report is generated including an identification of the new regulation, the decision, and the status update, and the report is provided for display.

### BACKGROUND

Regulations are constantly being created, modified, and re-interpreted, which creates challenges for businesses and other organizations that are expected to abide by those regulations. It requires a tremendous amount of manpower, time, coordination, and resources to identify new regulations, determine whether or not they are applicable, and then revise or design procedures around the new regulations. This is a manual, time consuming, and inefficient process that is prone to inconsistencies, waste, and difficulties every step of the way. Further, there is often no record of how various regulations are being implemented, if at all.

### BRIEF DESCRIPTION OF THE DRAWINGS

The accompanying drawings are incorporated herein and form a part of the specification.

FIG. 1 is a block diagram illustrating an example regulation control system (RCS), according to some embodiments.

FIG. 2 is an example user interface of the RCS, according to some example embodiments.

FIG. 3 is an example user interface of the RCS, according to some example embodiments.

FIG. 4 is an example user interface of the RCS, according to some example embodiments.

FIG. 5 is an example task creation user interface of the RCS, according to some example embodiments.

FIG. 6 is a flowchart illustrating example operations of a regulation control system (RCS), according to some embodiments.

FIG. 7 is an example computer system useful for implementing various embodiments.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a regulation control system.

Regulations are constantly being created, modified, and re-interpreted, which creates challenges for businesses and other organizations that are expected to abide by those regulations. It requires a tremendous amount of manpower, time, coordination, and resources to identify new regulations, determine whether or not they are applicable, and then revise or design procedures around the new regulations. This is a manual, time consuming, and inefficient process that is prone to inconsistencies, waste, and difficulties every step of the way. Further, there is often no record of how various regulations are being implemented, if at all.

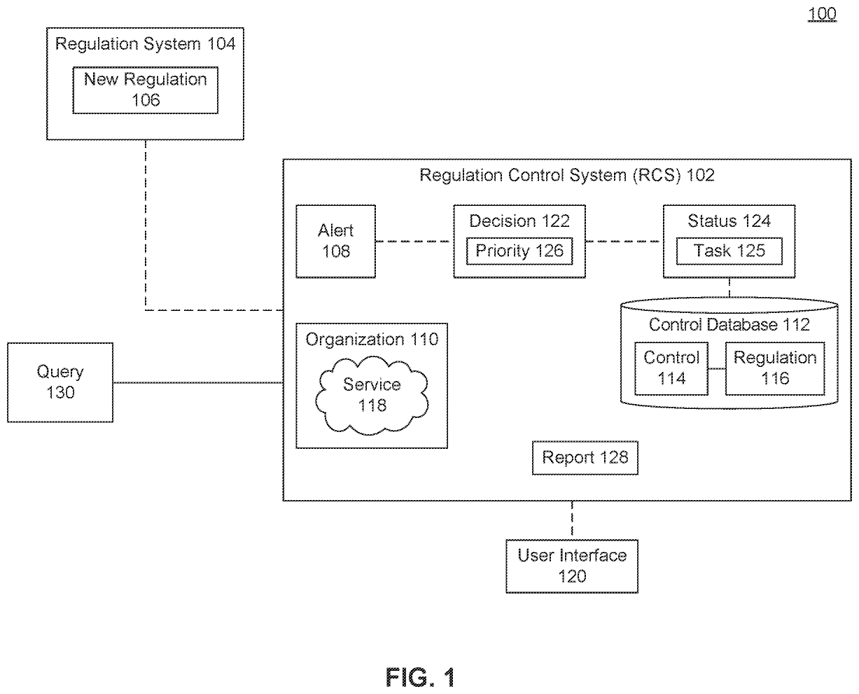

FIG. 1 is a block diagram 100 illustrating an example regulation control system (RCS) 102, according to some embodiments. RCS 102 may monitor a regulation system 104 for new regulations 106, generate an alert 108 for users, and track, monitor, and coordinate various processes or tasks to be performed by individuals and groups that may be required to respond to the new regulation 106 at an organizational level, to ensure the regulation 106 is being followed. RCS 102 may track and log the various personnel and their rationale for devising strategies for complying with a new regulation 106, and generate reports 128 which can be beneficial when responding to auditing requests or lawsuits.

Regulation system 104 may be a system where new, existing, and updated regulations are posted or made available to persons and/or organizations who may be impacted by those regulations. The regulations may include any law, guideline, ordinance, recommendation, or other regulation at a national, state, local, or industry level, which may be issued by a government agency, legal agency, or private organization, such as a trade group. The regulations may or may not be required to be followed, and may include best-practices in a field of industry. In some embodiments, regulation system 104 may be a server, website, data feed, set of documents, or other source of information that is accessible to RCS 102. In some embodiments, regulation system 104 may send emails or other electronic messages when regulations are updated or posted, which are received and processed by RCS 102.

In some embodiments, RCS 102 may monitor regulation system 104 for a new regulation 106. Regulation system 104 may post many different regulations, only a subset of which may be relevant for an organization 110. New regulation 106 may be any regulation that is new, has been updated, has expired/been repealed, or has otherwise been identified as being relevant or potentially relevant to organization 110.

For example, organization 110 may be a bank and new regulation 106 may include any new laws in banking or finance identified by RCS 102, but may not include new updates to food safety guidelines. RCS 102 may continuously or periodically search regulation system 104 for new regulations 106, or be provided notifications when a new regulation 106 potentially relevant to organization 110 has been posted. In some embodiments, RCS 102 may, upon identifying a new regulation 106, check a control database 112 to see if the new regulation 106 has been previously addressed by organization 110.

Control database 112 may include one or more storage devices that include information about existing controls 114 and regulations 116. The control-regulation pair may include a relationship between an existing regulation 116 and a control 114 (e.g., identifier of a control) that has been set up to address or comply with the regulation 116. In some embodiments, control 114 may be the name or identifier of a person, program, alert mechanism, system, operating guideline, or process indicating what process (if any) exists for a particular regulation 116 within the operating procedures of organization 110.

Control 114 may include any system, process, alert, or other mechanism put into place in an organization 110 (including in one of its computing systems) that is intended to ensure compliance with a specified regulation 116 (e.g., which may include a regulation title, number, source, date). In some embodiments, control 114 may be an automated or computerized process. In some embodiments, control 114 may include documentation of a manual process or role/person responsible for addressing a corresponding regulation 116.

For example, if regulation 116 indicates that IRS (internal revenue service) code 123 requires that the IRS is notified of deposits of more than $10,000, then the control 114 may include an indication or identifier of ATM 456 corresponding to an automated report that is generated each day of deposits of more than $10,000 and provided to a person at organization 110 responsible for doing the reporting, or that may be provided directly to the IRS (with a confirmation that may be sent to one or more individuals or roles in organization 110). In this example, control database 112 may include a regulation-control pair entry for (IRS Reg. No. 123, Jan. 13, 2020)-ATM456.

In some embodiments, RCS 102 may identify a new regulation 106 and verify whether or not the new regulation 106 exists in control database 112 as an existing or previously addressed regulation 116 (e.g., with a corresponding control 114). If the new regulation 106 exists in control database 112 as a regulation 116 (e.g., which may be identified based on a keyword or title, or name match), then RCS 102 may either skip the new regulation 106. If, however, the new regulation 106 does not exist in control database 112, RCS 102 may generate an alert 108.

Alert 108 may be a notification or other indication provided to one or more persons in organization 110 notifying that a new regulation 106 has been issued/identified and may require attention, such as the creation of a new control 114 or updating an existing control 114. For example, a new regulation 106 may be a modification or update to an existing regulation 116 which was addressed with control 114, but now control 114 may need to be updated in accordance with the modification or update. In some embodiments, new regulation 106 may include an expiration of an existing regulation 116, for which RCS 102 may generate an alert 108.

Organization 110 may be any type of group, community, or organization, including a business that follows regulations 106 that may be issued by one or more governance bodies other than organization 110, such as governments, trade groups, consortiums, etc. In some embodiments, organization 110 may provide a product or service 118 to one or more individuals or other organizations. Service 118 may include a line of business, product, team or department within or associated with organization 110, or a service provided to people or businesses inside or outside of organization 110. Service 118 may include any existing product lines or soon-to-be-offered or in development product lines of organization 110. In some embodiments, service 118 may be accessible from a database describing the various services 118 offered and/or soon-to-offered by organization 110.

In some embodiments, RCS 102 may determine whether new regulation 106 corresponds to a particular service 118 offered or soon-to-be-offered by organization 110. If there is a match between new regulation 106 and the service 118, alert 108 may include a reference to the identified service(s) 118. In some embodiments, alert 108 may also include an indication of any existing controls 114 that may be relevant to a corresponding regulation 116 (if any) that may be related to the new regulation 106.

If there is no identifiable match between new regulation 106 and service 118, RCS 102 may either disregard the new regulation 106 as irrelevant, or issue an alert 108 indicating no match to a service 118 was identified. In some embodiments, RCS 102 may send a first alert 108 of all the new regulations 106 for which a service 118 was not identified, and a second alert 108 for new regulations 106 for which a service 118 was identified (which may be a higher or different priority than the first alert 108). Then, for example, as described in greater detail below, decisions 122 may be made based on the priorities of the alerts 108.

In some embodiments, RCS 102 may determine that a new regulation 106 is relevant (or potentially relevant) to organization 110 based on keyword matching, based on determining that the new regulation 106 was issued by a particular trade group or regulatory body, based on a timeframe of the new regulation 106, and/or other factors. If RCS 102 determines that new regulation 106 is relevant to organization 110, then RCS 102 may issue a new alert 108.

In some embodiments, alert 108 may be a notification that a new regulation 106 needs to be addressed as it was identified as being relevant or potentially being relevant to organization 110. In some embodiments, the alert 108 may include an identification of an existing service 118 to which the new regulation 106 applies, or may apply. In some embodiments, if new regulation 106 is a modification of an existing regulation 116, alert 108 may include an identification of the existing regulation 116 and any corresponding controls 114 generated for the regulation 116. The alert 108 may be a preliminary indicator or relevancy or applicability of new regulation 106 to organization 110.

In some embodiments, the alert 108 may include an email, text message, or an alert on a user interface 120. In some embodiments, RCS 102 may track which users have accessed or viewed the alert 108 via the user interface 120 or by clicking a link in the notification/alert 108. User interface 120 may include an interface used by different members of organization 110 that provides information about new regulations 106 and controls 114 as described herein.

In some embodiments, organization 110 may include the roles and responsibilities for the organization 100, from which RCS 102 may identify who is responsible for the various processes in responding to a new regulation 106. In some embodiments, RCS 102 may provide the alert 108 to one or more users or groups responsible for the product or service 118 associated with the new regulation 106, or users responsible for creating a control 114 for the new regulation 106 as identified from the role and responsibilities of organization 110.

In some embodiments, the users receiving the initial alert 108 may review the new regulation 106 and submit a decision 122 via user interface 120, email, or other electronic submission. Decision 122 may be a final decision whether or not new regulation 106 is relevant to organization 110, and in some embodiments, may identify or confirm a service 118 affected by the new regulation 106.

The review may include a manual, human, or group review of the new regulation 106 to confirm whether or not the new regulation 106 applies to organization 110, and/or which services 118 and/or controls 114 may be affected by the new regulation 106. In some embodiments, the review may confirm or reject the indications in alert 108.

One or more members of the group or team performing the review of the new regulation 106 responsive to alert 108, may submit a decision 122 indicating yes or no whether the new regulation is applicable. In some embodiments, the decision 122 may include notes provided by one or more members performing the review indicating a rationale or thought behind the decision, and this may be logged by RCS 102 with the decision 122. If the decision 122 indicates that the new regulation 106 does not apply to organization 110, the process may complete and no further action may be taken on new regulation. In some embodiments, RCS 102 may log the new regulation 106 with its ‘inapplicable’ decision 122 and any submitted rationale in control database 112.

However, if decision 122 confirms that new regulation 106 is applicable to organization 110, the alert 108 or a new alert 108 may be provided to one or more roles or users responsible for developing a control 114 for the new regulation 106 (who may be identified from organization 110).

In some embodiments, a user may generate a task 125 for themselves or one or more other users via user interface 120 of RCS 102. Task 125 may include any activity related directly or indirectly to making decision 122 and/or generating a new control 114 for a new regulation 106. In some embodiments, task 125 may include an assigning user, an assigned user(s), a date assigned, a completion date, and any notes input by any users, including any updates to a status 124 of the task 125 and/or development of a control 114.

In some embodiments, users who have been provided an alert 108, assigned a task 125, have assigned a task 125, or who are otherwise responsible for the development of a control 114 for new regulation 106 may provide notes about their thoughts and/or progress with regards to new regulation 106. RCS 102 may receive these and other user inputs (which may include uploading documents) as status 124. Status 124 may include any notes provided by any user relevant to new regulation 106, their task 125, and/or the development of control 114. RCS 102 may log that user's identifier, their notes, the date of submission (and/or edit), the task 125 they are responsible for (if any), what team or role they are on, etc. in control database 112.

In some embodiments, status 124 may indicate a status of the processing of new regulation 106 and/or development of a new control 114 for the new regulation 106 as tracked or monitored by RCS 102. Status 124 may indicate, for example, what work or task(s) 126 has been completed, who it was assigned to, who completed it, the date of assignment, the date of completion, and any user submitted notes regarding the task 125. In some embodiments, status 124 may indicate a date of the new regulation 106, a date of the decision 122, and date it was assigned to the team or person(s) responsible for developing the control 114 for the new regulation 106.

In some embodiments, RCS 102 may periodically ping a developer or other user to provide an update to status 124 on a task 125 to which they are assigned. In some embodiments, RCS 102 may allow the pinged user to respond via user interface 120 with a status 124 such as: not yet started, in progress, in review, in testing, completed, estimated completion date, and provide any optional notes. In some embodiments, RCS 102 may allow a first user to ping or send an alert 108 to a second user to provide an update for status 124.

In some embodiments, RCS 102 may compute and assign a priority 126 to the decision 122 approving the development of a new control 114 (or modification of an existing control 114) in accordance with new regulation 106. In some embodiments, priority 126 may be based on a timeline of the new regulation 106 (e.g., when it is going into effect), a severity of the penalties for violation (e.g., fine amount, jail time, or other enumerated costs), a value of the service(s) 118 affected by the new regulation 106 (e.g. percentage of sales affected, a value indicator assigned to the services 118, etc.), or other factors.

In some embodiments, an initial priority 126 may be computed and assigned by RCS 102, and may be adjusted or tweaked by the role(s) and/or committee that reviews and submits the decision 122. In some embodiments, the priority 126 may be provided by the committee or person(s) submitting the decision 122.

In some embodiments, there may be multiple controls 114 under development or modification at any given time. As such, RCS 102 may use the priority 126 to determine where to allocate resources (e.g., manpower, money, computing resources, or how to rank tasks 125) so that the highest priority new regulation 126, control 114, and/or task 125 is completed first or assigned the most resources.

As new regulations 106 are assigned a priority 126, that priority may affect the development of other lower controls 114 for lower priority regulations 116 which may currently be in progress. In some embodiments, RCS 102 may reorder existing regulations to account for the higher priority 126 of the new regulation 106. This ordering based on priority 126 may help users or members of organization 110 know what to prioritize and work on first, second, etc. by logging into RCS 102 via user interface 120 to see their tasks 125 which may be organized into a task list.

In some embodiments, RCS 102 may generate a new alert 108 to different users who may be affected by the reordering. For example, if a first user is assigned a task 126 for a first regulation with a low priority, the first user may receive an alert 108 to work on tasks 125 for the new regulation 106 with a higher priority first. This alert 108 may be sent via email, instant message, or another electronic messaging system. In some embodiments, RCS 102 may reorder the tasks 125 assigned to the first user in accordance with the priority 126 of the corresponding regulations 116 or controls 114, and may generate an alert 108 indicating the tasks 125 have been reordered.

In some embodiments, RCS 102 may generate a report 128. Report 128 may include a listing indicating the status 124 of various controls 114 that are in progress to address identified new regulations 106. The report 128 may include user-provided notes and their date of submission. The report 128 may capture the rationale or thinking of the decision makers in how and why they implemented control 114 in the manner they did, and may provide a historical record of why a new regulation 106 was not implemented into a control 114, or indicating how it has already been addressed by an existing control 114. Report 128 may be beneficial to ensure compliance with standards and laws in the industry of the corporation, which can improve consumer safety, and may be helpful in case of audits or legal disputes alleging that organization 110 did not follow a particular regulation 116.

For example, organization 110 may receive an audit from a government agency or a lawsuit indicating that the organization 110 (or its agents) failed to follow a particular regulation 116. In some embodiments, the relevant regulation(s) to the audit or lawsuit may be received as a query 130. RCS 102 may then identify from control database 112 information regarding the regulation 116, its corresponding control 114 (if any), and all the notes, including the decision 112 as to how and why it was or was not implemented. In some embodiments, RCS 102 may generate a report 128 responsive to the query 130, and may provide the report 128 for display on user interface 120 or electronically transmit the report 128 to one or more identified users or government agencies.

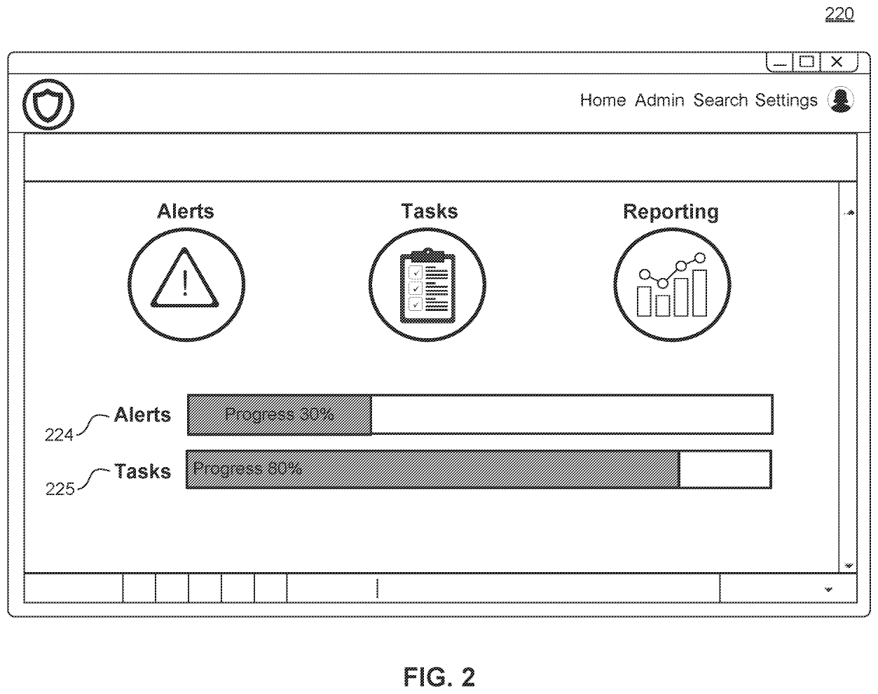

FIG. 2 is an example user interface 220 of the RCS 102, according to some example embodiments. User interface 220 may allow a user to select various user interface icons or buttons for alerts functionality, a tasks functionality, or a reporting functionality. A selection of the alerts button may allow the user to see details on what alerts 108 have been issued, who received the alerts 108, and any responses or actions taken responsive to the alerts by the users. In some embodiments, a selection of the alerts button may allow the user to see what alerts 108 have been issued to the user.

A selection of the tasks button may allow the user to see details on tasks 125 issued to the user or issued by the user, both active and completed. In some embodiments, a selection of the tasks button may allow the user to see what tasks 125 have been assigned to different users across one or more controls 114 and/or new regulations 106, and their status 124. In some embodiments, a selection of the tasks button may allow the user to assign tasks, mark assigned tasks as completed, or provide notes.

A selection of the reporting button may provide details on generated reports 128, or allow the user to generate specific reports on any tracked information or metrics from RCS 102. In some embodiments, a selection of reporting may allow the user to submit a query 130 on a particular control 114 or regulation 116, which may cause RCS 102 generate a report 128 detailing the history of work and notes that have been submitted on the queried control 114 or regulation 116.

The alerts bar 224 may illustrate an overall progress that has been made on the various outstanding alerts 108 for which the user is responsible, or members of a team of the user are responsible. The tasks bar 225 may illustrate an overall progress that has been made on the various tasks 125 for which the user is responsible, or members of a team of the user are responsible.

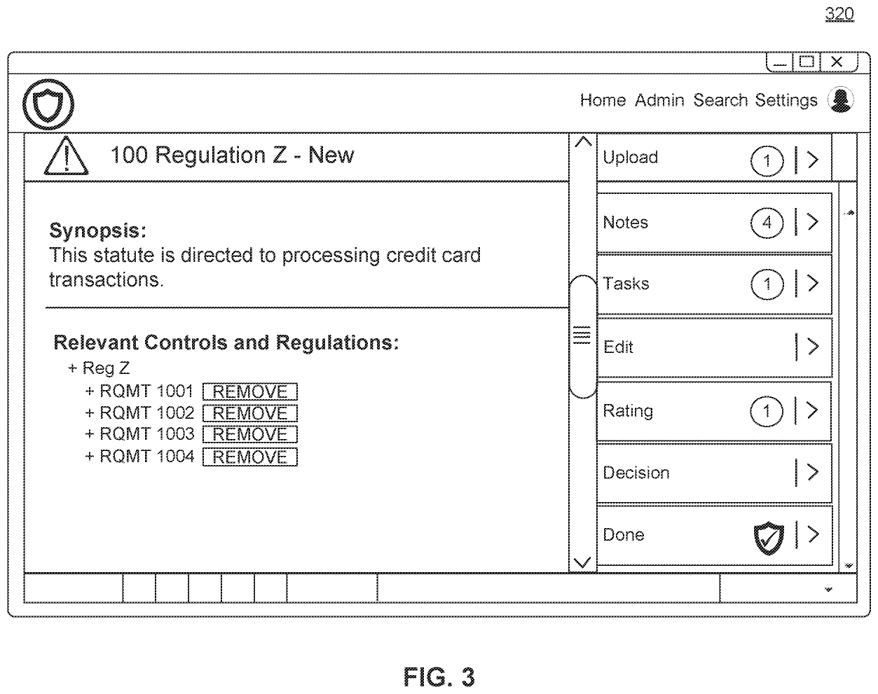

FIG. 3 is an example user interface 320 of the RCS 102, according to some example embodiments. User interface 320 shows a new regulation 106, titled regulation Z with a synopsis of the regulation which may have been received from or extracted from regulation system 104.

The bottom of the screen illustrates relevant controls 114 and/or regulations 116 which RCS 102 may have identified from control database 112 that are deemed similar or relevant to the new regulation 106, regulation z. The identified regulations include a remove command which a user may use to remove an existing control 114 or regulation 116, because it was deemed inapplicable or irrelevant.

On the right hand of the example user interface 320, there are various boxes that allows a user to check on the status 124 of the development of a control 114 for regulation z. Upload may indicate how many documents have been uploaded. Notes may indicate how many notes have been provided by users. The “Tasks” tab may indicate how many outstanding tasks 125 there are. The “Rating” tab may allow a user to see or adjust a priority of the regulation z. In some embodiments, rating may correspond to or indicate an urgency of a particular action or developing a control for a particular regulation. For example, rating may be a value between 1-100, and a rating of 100 may be a high priority, as soon as possible urgency, while a rating of 50 may be a lower priority, do it at your leisure (or within a specified time period, such as 3 months). The ratings may change over time. In some embodiments, one or more individuals who are assigned or who have previously worked on alerts may have the authority to set or adjust a rating.

The “Decision” tab may allow a user to see any details regarding the decision 122 which may include when the decision 122 was made, by whom, and any rationale provided to RCS 102. The “Done” tab may allow the user to exit the current regulation z, and select a different regulation or user interface 120. In some embodiments, the “Done” tab may indicate that everything has been completed for the review, which may trigger forwarding the decision 122 and/or regulation to one or more other users to perform actions based on the decision 122.

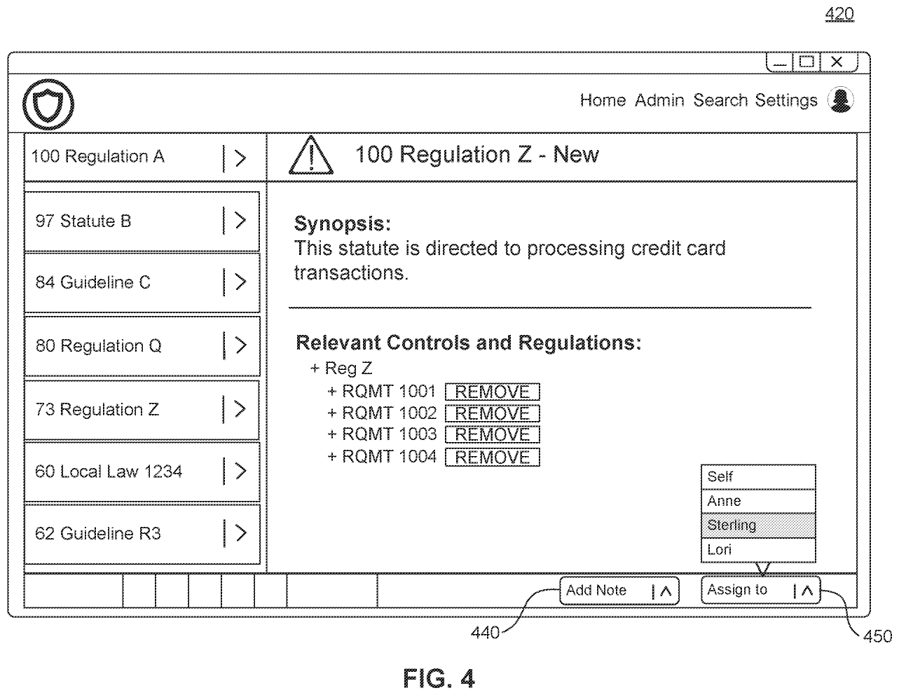

FIG. 4 is an example user interface 420 of the RCS 102, according to some example embodiments. In the example user interface 420, on the left side of the screen are the various outstanding new regulations 106 and their relative priority 126. As can be seen, the priority 126 of regulation z may be 73. In some embodiments, priority 126 may be a risk indicator, indicating a potential risk or liability to organization 110.

Box 440 may allow a user to add a note or comment about regulation Z. In some embodiments, any user added comments may be illustrated in the main box underneath the synopsis in addition to the relevant controls and regulations section (if any).

Box 450 may allow a user to assign the development of control 114 for regulation z to a particular user in organization 110. In some embodiments, box 450 may allow a user to create or assign a task 125 to one of the enumerated users.

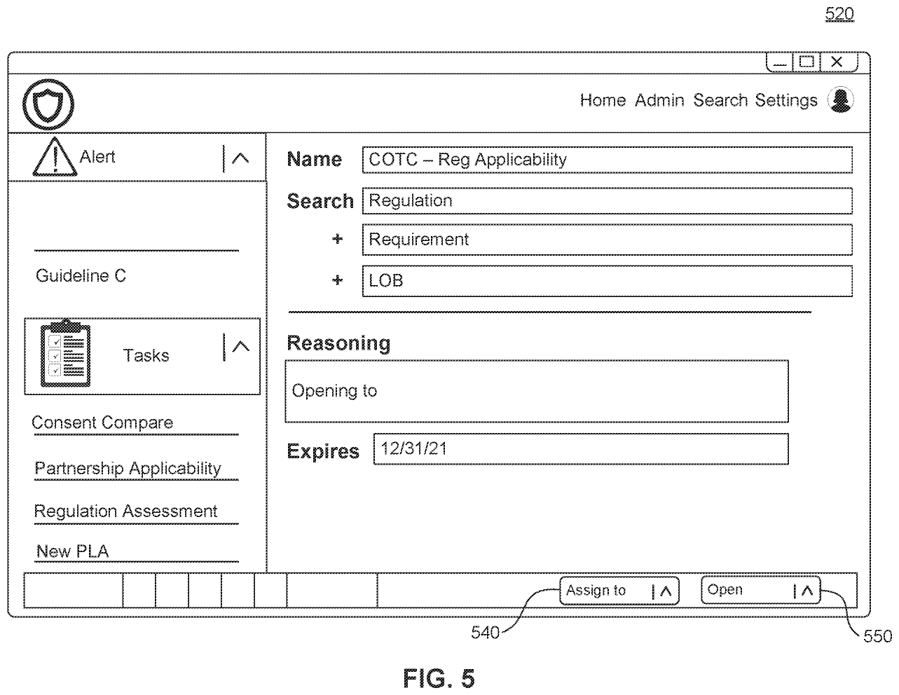

FIG. 5 is an example task creation user interface 520 of the RCS 102, according to some example embodiments. RCS 102 may enable a user to generate a new task 125 using user interface 520. A user may provide a task name, identify a regulation (which may be identified on the left side as “Guideline C”, any requirements, and an LOB (line of business) or service 118 that may be relevant.

In the reasoning field, a user can enter any notes. In the expires field, a user may indicate a due date for the task. Box 540 may allow a user to assign the task to one or more other users. Box 550 may allow the user to open one or more new or different tasks 125.

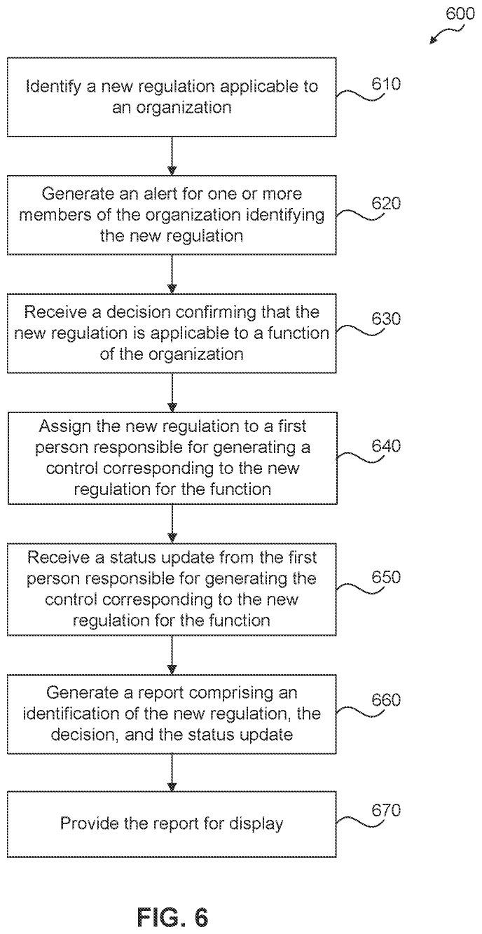

FIG. 6 is a flowchart of a method 600, illustrating example operations of a regulation control system (RCS) 102, according to some embodiments. Method 600 can be performed by processing logic that can comprise hardware (e.g., circuitry, dedicated logic, programmable logic, microcode, etc.), software (e.g., instructions executing on a processing device), or a combination thereof. For example, various steps in method 600 may be performed using one or application programming interfaces (APIs) operating on one or more processing devices. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIG. 1. However, method 600 is not limited to the example embodiments thereof.

In 610, a new regulation applicable to an organization is identified. For example, RCS 102 may identify that new regulation 106 from regulation system 104 is applicable to organization 110 based on a query word and/or date search. In some embodiments, RCS 102 search a database of regulations posted by regulation system 104 for keywords and phrases that correspond to functions, lines of business, or services 118 associated with or performed by organization 110.

In 620, an alert is generated for one or more members of the organization identifying the new regulation. For example, RCS 102 may generate an alert 108 for one or more members of organization 110 indicating that a new regulation 106 (or set of new regulations 106) has been identified, or that there are changes or updates needed to an existing or previously addressed regulation 106.

In 630, a decision is received confirming that the new regulation is applicable to a function of the organization. For example, RCS 102 may receive a decision 122 indicating that the new regulation 106 is or is not applicable to organization 110. The decision 122 may confirm the identification that the new regulation 106 is relevant to one or more services 118 offered or performed by organization 110. In some embodiments, decision 122 may confirm or include an adjustment to priority 126 as assigned by RCS 102.

In 640, the new regulation is assigned to a first person responsible for generating a control corresponding to the new regulation for the function. For example, organization 110 may include a chart that indicates who is responsible for handling new regulation 106 after a decision 122 has been made. In some embodiments, the names or roles of one or more persons associated with developing the control 114 may be identified and an alert 108 with one or more RCS 102 generated tasks 125 may be provided to the identified names or roles. In 650, a status update is received from the first person responsible for generating the control corresponding to the new regulation for the function. For example, RCS 102 may update status 102 when decision 122 is received, and a new task 125 is assigned to one or more individuals or roles who are responsible for developing control 114. In some embodiments, RCS 102 may periodically (e.g., weekly, bi-weekly, monthly, etc.) send alerts 108 the users to whom tasks 115 have been assigned, requesting status updates for status 124. For example, status 124 updates received from the users may indicate whether the user has begun working on the task, when they plan on beginning work, the estimated completion time, and/or any user provided notes.

In 660, a report comprising an identification of the new regulation, the decision, and the status update is generated. For example, RCS 102 may generate report 128 regarding a new regulation 106, an existing regulation 116, and/or one or more controls 114 in development or which have been completed. The report 128 may include a chronological accounting of who worked on which tasks 125 and any notes and updates to status 124 provided by those users. In some embodiments, RCS 102 may receive a query 130 identifying a regulation 116, new regulation 106, and/or control 114 on which to generate a report 128. In some embodiments, the query 130 may identify a particular user, and RCS 102 may generate a report on all the tasks, notes, and other actions provided by that user to RCS 102 over an identified time period.

In 670, the report is provided for display. For example, RCS 102 may display report 128 on user interface 120. In some embodiments, RCS 102 may transmit the report via an email, text message, or other electronic messaging system to one or more identified users or systems outside of RCS 102, including government agencies, law firms, etc.

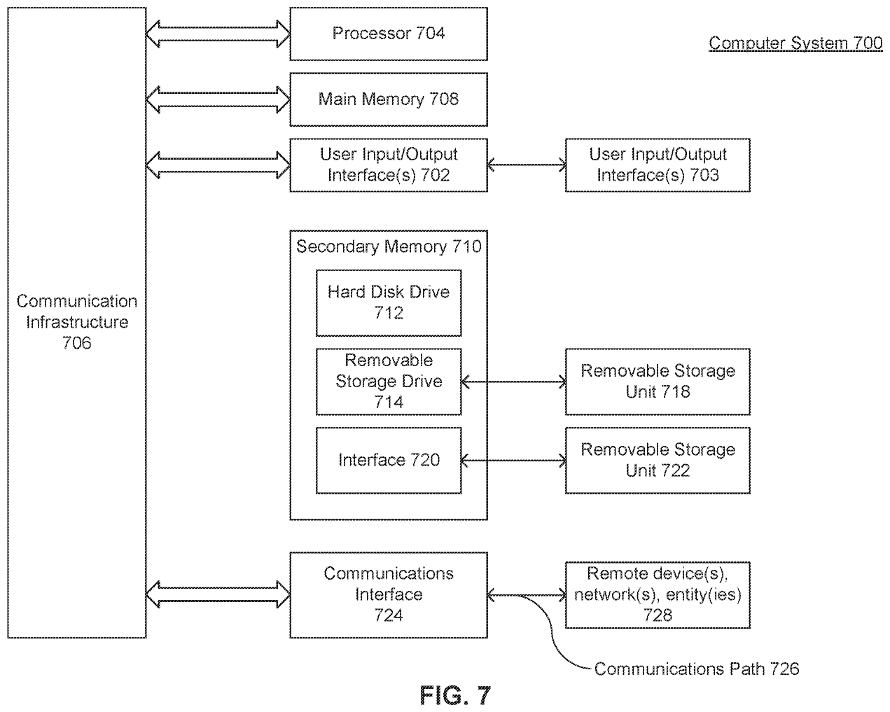

Various embodiments may be implemented, for example, using one or more well-known computer systems, such as computer system 700 shown in FIG. 7. One or more computer systems 700 may be used, for example, to implement any of the embodiments discussed herein, such as image rectification system 102 and/or method 200, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include customer input/output device(s) 703, such as monitors, keyboards, pointing devices, etc., which may communicate with communication infrastructure 706 through customer input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards. In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
identifying, by one or more computing devices, a new regulation that is applicable to an organization;
generating, by the one or more computing devices, an alert for one or more members of the organization applicable to the new regulation;
receiving a decision, from the one or more members, confirming that the new regulation is applicable to a function of the organization;
assigning the new regulation to a first person responsible for generating a control corresponding to the new regulation for the function;
receiving a status update from the first person responsible for generating the control corresponding to the new regulation for the function;
generating a report comprising an identification of the new regulation, the decision, and the status update; and
providing the report for display.

2. The method of claim 1, wherein the identifying comprises:
monitoring one or more network devices configured to make available a plurality of regulations; and
identifying the new regulation, from the plurality of regulations, based on the monitoring.

3. The method of claim 1, wherein the receiving the decision comprises:
receiving a priority regarding the new regulation;
identifying at least one previously identified regulation with a previous regulation priority; and
reordering the new regulation and the at least one previously identified regulation based on a comparison of the priority regarding the new regulation with the previous regulation priority.

4. The method of claim 3, wherein the reordering comprises:
generating an alert to one or more users assigned to generate a previous control for the at least one previously identified regulation that the new priority associated with the new regulation is higher than the previous regulation priority.

5. The method of claim 1, wherein the receiving the decision comprises:
receiving notes regarding the decision; and
wherein the report includes the notes regarding the decision.

6. The method of claim 1, wherein the assigning comprises:
receiving a user-generated task for one or more members of the group; and
providing the user-generated task to the group.

7. The method of claim 1, wherein the generating comprises:
receiving a query corresponding to a lawsuit or audit associated with the new regulation;
generating the report responsive to the query.

8. A system comprising:
a memory; and
at least one processor coupled to the memory and configured to perform operations comprising:
identifying a new regulation that is applicable to an organization;
generating an alert for one or more members of the organization applicable to the new regulation;
receiving a decision, from the one or more members, confirming that the new regulation is applicable to a function of the organization;
assigning the new regulation to a first person responsible for generating a control corresponding to the new regulation for the function;
receiving a status update from the first person responsible for generating the control corresponding to the new regulation for the function;
generating a report comprising an identification of the new regulation, the decision, and the status update; and
providing the report for display.

9. The system of claim 8, wherein the identifying comprises:
monitoring one or more network devices configured to make available a plurality of regulations; and
identifying the new regulation, from the plurality of regulations, based on the monitoring.

10. The system of claim 8, wherein the receiving the decision comprises:
receiving a priority regarding the new regulation;
identifying at least one previously identified regulation with a previous regulation priority; and
reordering the new regulation and the at least one previously identified regulation based on a comparison of the priority regarding the new regulation with the previous regulation priority.

11. The system of claim 10, wherein the reordering comprises:
generating an alert to one or more users assigned to generate a previous control for the at least one previously identified regulation that the new priority associated with the new regulation is higher than the previous regulation priority.

12. The system of claim 8, wherein the receiving the decision comprises:
receiving notes regarding the decision; and
wherein the report includes the notes regarding the decision.

13. The system of claim 8, wherein the assigning comprises:
receiving a user-generated task for one or more members of the group; and
providing the user-generated task to the group.

14. The system of claim 8, wherein the generating comprises:
receiving a query corresponding to a lawsuit or audit associated with the new regulation;
generating the report responsive to the query.

15. A non-transitory computer-readable medium having instructions stored thereon that, when executed by one or more processors, cause the one or more processors to perform operations comprising:
identifying a new regulation that is applicable to an organization;
generating an alert for one or more members of the organization applicable to the new regulation;
receiving a decision, from the one or more members, confirming that the new regulation is applicable to a function of the organization;
assigning the new regulation to a first person responsible for generating a control corresponding to the new regulation for the function;
receiving a status update from the first person responsible for generating the control corresponding to the new regulation for the function;
generating a report comprising an identification of the new regulation, the decision, and the status update; and
providing the report for display.

16. The non-transitory computer-readable medium of claim 15, wherein the identifying comprises:
monitoring one or more network devices configured to make available a plurality of regulations; and
identifying the new regulation, from the plurality of regulations, based on the monitoring.

17. The non-transitory computer-readable medium of claim 15, wherein the receiving the decision comprises:
receiving a priority regarding the new regulation;
identifying at least one previously identified regulation with a previous regulation priority; and
reordering the new regulation and the at least one previously identified regulation based on a comparison of the priority regarding the new regulation with the previous regulation priority.

18. The non-transitory computer-readable medium of claim 17, wherein the reordering comprises:
generating an alert to one or more users assigned to generate a previous control for the at least one previously identified regulation that the new priority associated with the new regulation is higher than the previous regulation priority.

19. The non-transitory computer-readable medium of claim 15, wherein the receiving the decision comprises:
receiving notes regarding the decision; and
wherein the report includes the notes regarding the decision.

20. The non-transitory computer-readable medium of claim 15, wherein the assigning comprises:
receiving a user-generated task for one or more members of the group; and
providing the user-generated task to the group.
